(19) United States
(12) Patent Application Publication
(10) Pub. No.: US 2026/0281005 A1
(43) Pub. Date: Sep. 17, 2026

(54) METHODS, APPARATUS AND SYSTEMS FOR NETWORK CONFIGURATION

(71) Applicant: Telefonaktiebolaget LM Ericsson (publ), Stockholm (SE)

(72) Inventors: Perepu SATHEESH KUMAR, Chennai (IN); Saravanan M, Chennai (IN)

(73) Assignee: Telefonaktiebolaget LM Ericsson (publ), Stockholm (SE)

(21) Appl. No.: 19/469,142

(22) PCT Filed: Mar. 28, 2023
(86) PCT No.: PCT/IN2023/050291

§ 371 Date: Sep. 25, 2025

(51) Int. Cl. H04L 41/16; H04L 41/0816; H04L 41/082; H04L 41/14; H04W 24/02

(52) U.S. Cl. CPC H04L 41/16; H04L 41/0816; H04L 41/082; H04L 41/145; H04W 24/02

(57) ABSTRACT

Methods, apparatus and systems for network configuration are provided. A computer-implemented method for modifying the configuration of a communication network using a ML agent comprises receiving first and second network modification proposals proposal agents. The method further comprises generating a third proposal using the first and second proposals. The method also comprises predicting the effect of the implementation of the proposals on a state of the communication network using a simulated communication network, wherein the simulated communication network simulates the state of the communication network. The method further comprises selecting one of the proposals based on the predicted implementation effects and, where the third proposal is selected, determining respective weightings of the first and second proposals in the third proposal. The method still further comprises initiating the modification of the communication network based on the selected proposal.

### TECHNICAL FIELD

Embodiments described herein relate to methods and apparatus for network configuration, in particular for utilising a Machine Learning (ML) agent to assist in the configuration of a communication network.

### BACKGROUND

Networks, such as 3^{rd} Generation Partnership Project (3GPP) 5^{th} Generation (5G) communications networks, 3GPP 6^{th} Generation (6G) communications networks, Institute of Electrical and Electronics Engineers (IEEE) standard 802.11 compliant networks (which may be referred to as WiFi networks), and so on, may be utilised to provide communication coverage to an environment. The environment may be a particular volume of space comprising, for example, all or part of a country.

Any suitable form of transceiver may be used to supplement or provide network coverage. The form of the transceiver may be determined based on the nature of the network, for example, where the network is a WiFi network, suitable WiFi transceivers may be provided. Where the network is a 5G or 6G network, corresponding base stations may be provided. It may be necessary or desirable to vary the configuration of one or more components within a communication network, in order to provide the desired network capability. By way of example, when the amount of communication traffic to be carried by a network increases, it may be desirable to provide additional network capacity (by increasing a number of active base stations, refocussing base stations, and so on). The performance of some networks may be monitored using Key Performance Indicators (KPI), including latency, Quality of Experience (QoE) of users, packet loss rates, and so on. Where KPI monitoring is used, network configuration alterations may be used to ensure that one or more KPIs do not fall below predetermined thresholds. The predetermined thresholds may be set, for example, by internal network overseers (which may be human or software overseers) or by network operators. The predetermined thresholds may be set by way of intents, that is, an intent may comprise a target value (or aim) for one or more KPIs. The process of controlling and (if necessary) altering the configuration of a network may be referred to as network orchestration. Intent-based networking is an example of network orchestration. In some systems implementing intent-based networking, ML may be used to automate some aspects of the process for converting intents into changes made to a network. Intent-based network orchestration may utilise a centralized rule-based policy, shared knowledge objects, and logical segmentations together to create a sustainable automation framework for implementing business requirements in a network.

Some existing rule-based intent networking utilizes the intents and orchestration frameworks for implementing a requirement on the network. Agents may be used to generate proposals to be implemented on networks, and to report on the response of the network to proposals. Closed-loop monitoring may be used to ensure the system receives feedback from the network and reporting agents. Automation and analytics may also be used to enable faster detection of threats and downtime reduction. “Closed-loop monitoring systems for detecting impending instability” by Kim, T. and Abed, E. H, IEEE Transactions on Circuits and Systems, available at https://ieeexplore.ieee.org/document/886978 as of 13 Mar. 2023 discusses how closed-loop monitoring may be provisioned to ensure a system receives feedback from a network and reporting agents. Typically, in existing systems, reporting is provided at a high frequency, which can be computationally intensive. Issues may also arise in existing systems when multiple intents are received, particularly in situations where network changes that may address an intent conflict with one another. It is desirable to provide a system to address multiple intents necessitating potentially conflicting modifications for implementation.

### SUMMARY

It is an object of the present disclosure to provide methods, apparatus and computer-readable media which at least partially address one or more of the challenges discussed above. In particular, it is an object of the present disclosure to support efficient implementation of network modifications to address intents. It is also an object to save network resources by avoiding unnecessary evaluations.

The present disclosure provides methods, apparatuses and systems for modifying the configurations of communication networks. Embodiments may achieve intents efficiently through the combination of proposals from multiple agents to be applied together. Intents from agents that may require sequential actions may be integrated for execution in a network, thereby increasing the generalised applicability of embodiments. Embodiments may additionally or alternatively save computational resources (memory, processor time, and so on) by omitting one or more evaluations of the network.

An embodiment provides a computer-implemented method for modifying the configuration of a communication network using a ML agent. The method comprises receiving a first network modification proposal from a first proposal agent and a second network modification proposal from a second proposal agent. The method further comprises generating a third network modification proposal using the first network modification proposal and the second network modification proposal. The method also comprises predicting the effect of the implementation of the first network modification proposal, the second network modification proposal and the third network modification proposal on a state of the communication network using a simulated communication network, wherein the simulated communication network simulates the state of the communication network. The method further comprises selecting one of the network modification proposals based on the predicted implementation effects and, where the third network modification proposal is selected, determining respective weightings of the first network modification proposal and second network modification proposal in the third network modification proposal. The method still further comprises initiating the modification of the communication network based on the selected network modification proposal.

A further embodiment provides a ML agent configured modify the configuration of a communication network using a ML model. The ML agent comprises processing circuitry and a memory containing instructions executable by the processing circuitry. The ML agent is operable to receive a first network modification proposal from a first proposal agent and a second network modification proposal from a second proposal agent. The ML agent is further operable to generate a third network modification proposal using the first network modification proposal and the second network modification proposal. The ML agent is also operable to predict the effect of the implementation of the first network modification proposal, the second network modification proposal and the third network modification proposal on a state of the communication network using a simulated communication network, wherein the simulated communication network simulates the state of the communication network. The ML agent is further operable to select one of the network modification proposals based on the predicted implementation effects and, where the third network modification proposal is selected, determine respective weightings of the first network modification proposal and second network modification proposal in the third network modification proposal. The ML agent is still further operable to initiate the modification of the communication network based on the selected network modification proposal.

Embodiments of the disclosure are discussed below. The scope of the disclosure is defined by the claims.

### BRIEF DESCRIPTION OF DRAWINGS

The present disclosure is described, by way of example only, with reference to the following figures, in which:

FIG. 1 is a flowchart of a method in accordance with embodiments;

FIG. 2A is schematic diagram of a ML agent in accordance with embodiments;

FIG. 2B is schematic diagram of a ML agent in accordance with embodiments;

FIG. 3 is a schematic illustration of a typical RL system;

FIG. 4 is a schematic diagram showing an example of a system in accordance with some embodiments; and

FIG. 5A and FIG. 5B are results plots showing an example of the effect of an embodiment on the time taken to reach KPI targets.

### DETAILED DESCRIPTION

For the purpose of explanation, details are set forth in the following description in order to provide a thorough understanding of the embodiments disclosed. It will be apparent, however, to those skilled in the art that the embodiments may be implemented without these specific details or with an equivalent arrangement.

Embodiments provide systems for predicting the effect of plural proposals for achieving plural intents may have on a communication network and then selecting a proposal for implementation based on the predicted effects of the proposals, and initiating the modification of the communication network based on the selected proposal.

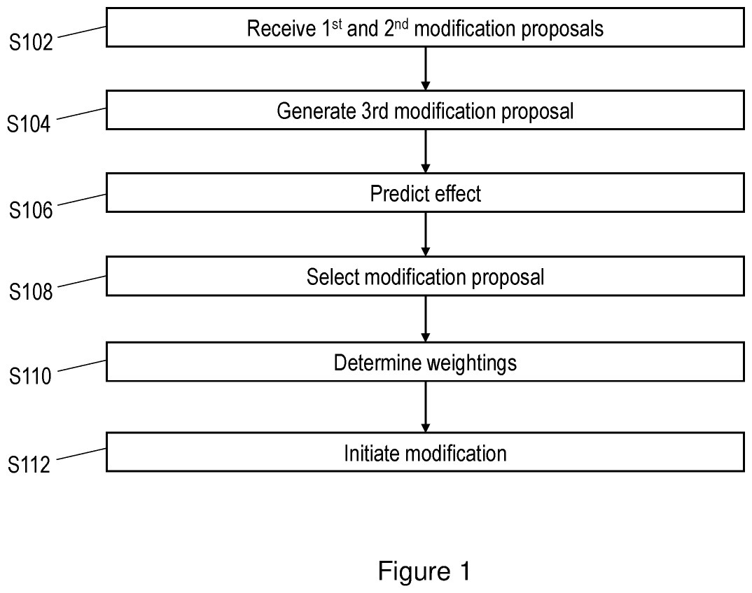

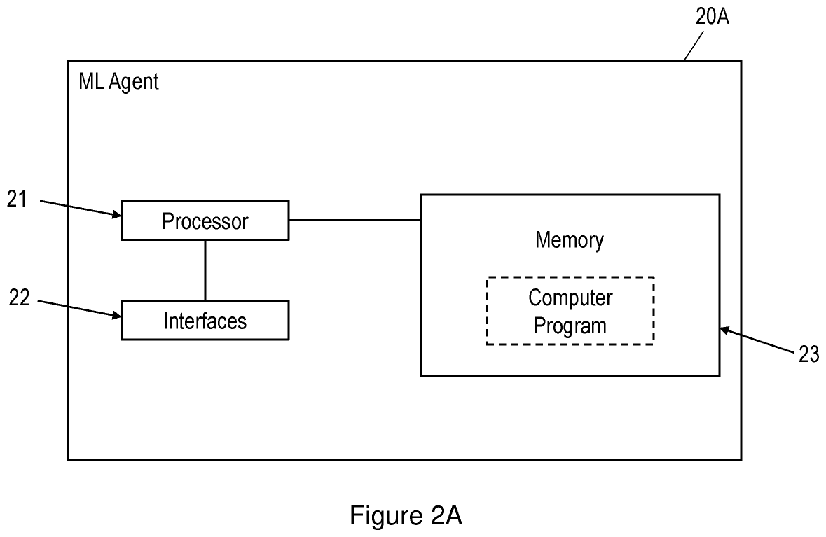

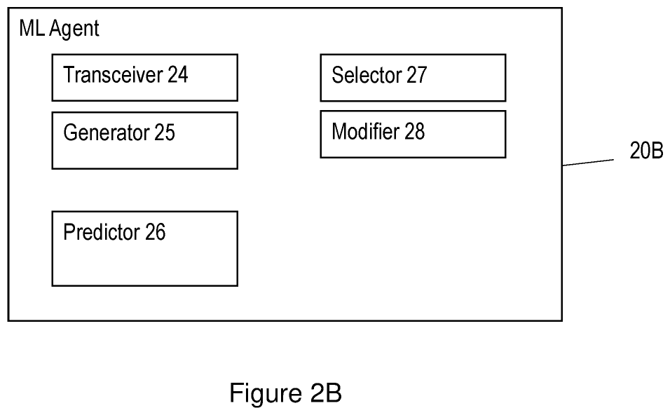

A method in accordance with embodiments is illustrated by FIG. 1, which is a flowchart showing a method for modifying the configuration of a communication network using a ML agent. The computer-implemented method may be performed by any suitable apparatus, for example, by a ML agent 20A, 20B such as those shown in FIG. 2A and FIG. 2B (collectively FIG. 2). Where the network is a communications network or WiFi network (or part of the same), the method may be performed by an apparatus (such as a ML agent) that is or forms part of a network node, such as a base station or core network node (or may be incorporated in a base station or core network node). The communications network may be for example a 5G network or 6G network. In some embodiments, the ML agent may form part of an transceiver or a controller of transceivers. In some embodiments ML agents may be used for multiple steps, accordingly the ML agent used may be one (or more) of a proposal agent or proposal agents, an agent hosting a prediction ML model, an agent hosting a weighting ML model, and an agent hosting an implementation ML model. The various agents and ML models are discussed in greater detail below.

As shown in step S102 of FIG. 1, the method comprises receiving a first network modification proposal from a first proposal agent, and receiving a second network modification proposal from a second proposal agent. The step of receiving first and second network modification proposals may be performed in accordance with a computer program stored in a memory 23, executed by a processor 21 in conjunction with one or more interfaces 22 of ML agent 20A, as illustrated by FIG. 2A. Alternatively, the step of receiving first and second network modification proposals may be performed by transceiver 24 of ML agent 20B, as shown in FIG. 2B. In some embodiments the proposals may be generated by the first and second proposal agents based on first and second intents respectively; the intents may be received from any suitable source such as an internal network orchestrator or external customer requirement. The proposals may be received, for example by a ML agent 20 as discussed above. Additional proposals may also be received (for example, a third proposal, fourth proposal, and so on) and processed as discussed below, however for simplicity an embodiment in which two proposals are received is discussed here. Some embodiments may comprise a system including some or all of the proposal agents generating proposals, as well as the ML agent receiving the proposal(s). In some embodiments, the proposal agents may generate the network modification proposals based on intended KPIs for the communications network; by way of example an intent of decreasing latency received by a proposal agent may result in the proposal agent generating a proposal (to address the intent) to adjust various network configuration options (activate part or all of one or more base stations, adjust the antenna tilt settings of one or more base station antennas, and so on). In some embodiments, proposal agents may generate the proposals using rule-based agents, or using ML models, or a combination of these or any other suitable techniques.

Where one or more of the proposal agents generating proposals utilise ML models, these ML models may be trained in any suitable way. An example of a suitable training method is utilising Reinforcement Learning, RL. RL allows a ML model to learn by attempting to maximise an expected cumulative reward for a series of actions utilising trial-and-error. RL agents (that is, a system which uses RL in order to improve ML model performance in a given task over time) may be closely linked to the system (environment) they are being used to model/control, and learn through experiences of performing actions that alter the state of the environment. Additionally or alternatively, RL may be used to train a ML model wherein a simulation of an environment is used, before the trained ML model is used to control an actual environment; this option may be of use where it is desirable to avoid having an untrained or partially trained ML model controlling an actual operating environment.

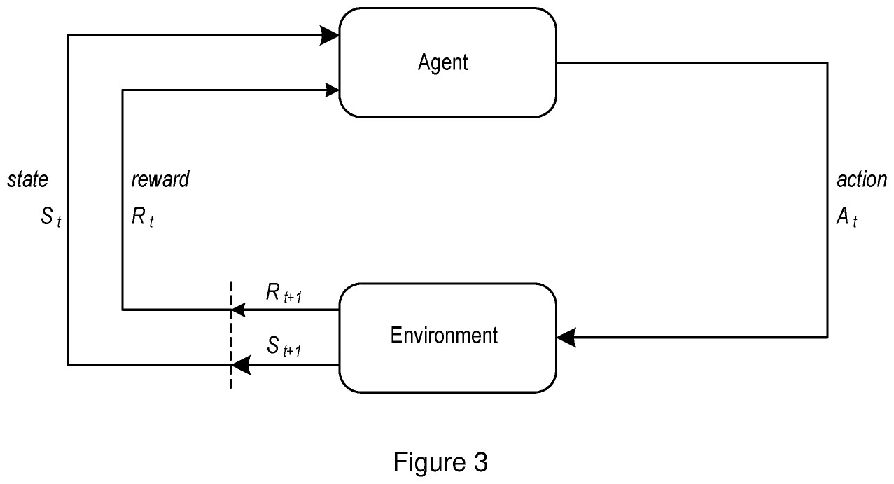

FIG. 3 illustrates schematically a typical RL system. In the architecture shown in FIG. 3, an agent receives data from, and transmits actions to, the environment which it is being used to model/control (which may be a real environment or a simulated environment). For a time t, the agent receives information on a current state of the environment St. The agent then processes the information St, and generates one or more actions to be taken; one of these actions is to be implemented At. The action At to be implemented is then transmitted back to the environment and put into effect. The result of the action At is a change in the state of the environment with time, so at time t+1 the state of environment is St+1. The action also results in a (numerical, typically scalar) reward Rt+1, which is a measure of effect of the action At resulting in environment state St+1. The changed state of the environment St+1 is then transmitted from the environment to the agent, along with the reward Rt+1. FIG. 3 shows reward Rt being sent to the agent together with state St; reward Rt is the reward resulting from action At−1, performed on state St−1. When the agent receives state information St+1 this information is then processed in conjunction with reward Rt+1 in order to determine the next action At+1, and so on. The action to be implemented is selected by the agent from actions available to the agent with the aim of maximising the cumulative reward. RL can provide a powerful solution for dealing with the problem of optimal decision making for agents interacting with uncertain environments.

In some embodiments, the first proposal agent and the second proposal agent may generate the network modification proposals based on intended KPIs for the communications network. Any suitable KPIs, as will be familiar to those skilled in the art, may be included in intents; examples include Quality of Experience (QoE) measures, packet loss measurements, latency values, and so on.

When the first and second network modification proposals have been received, the method continues with the generation of a third network modification proposal using the first network modification proposal and the second network modification proposal, as shown in step S104 of FIG. 1. The step of generating the third network modification proposal may be performed in accordance with a computer program stored in a memory 23, executed by a processor 21 in conjunction with one or more interfaces 22 of ML agent 20A, as illustrated by FIG. 2A. Alternatively, the step of generating the third network modification proposal may be performed by generator 25 of ML agent 20B, as shown in FIG. 2B. The third network modification proposal is generated using the first and second network modification proposals; in some embodiments the third network modification proposal is generated by combining the first and second network modification proposals, alternatively the third network modification proposal may be obtained by analysing the first and second network modification proposals and generating a third network modification proposal based on this analysis. Where the third network modification proposal is generated by combining the first and second network modification proposals, the third network modification proposal may be referred to as a combined network modification proposal.

Following the generation of the third network modification proposal (which, as discussed above, may be a combined network modification proposal), the method then continues with the step of predicting the effect of each of the network modification proposals on a state of the communication network, as shown in step S106 of FIG. 1. The step of predicting the effect of each of the network modification proposals may be performed in accordance with a computer program stored in a memory 23, executed by a processor 21 in conjunction with one or more interfaces 22 of ML agent 20A, as illustrated by FIG. 2A. Alternatively, the step of predicting the effect of each of the network modification proposals may be performed by predictor 26 of ML agent 20B, as shown in FIG. 2B.

The prediction is made utilising a simulated communication network that simulates the state of the (real) communication network. The simulated communication network may be referred to as a digital twin of the real world communication network and may be hosted in, for example, a network emulator. In this context, the state of the communication network may comprise one or more of: the configuration of one or more base stations in the communication network, the distribution of network traffic in the communication network, the performance of the network relative to KPIs, and so on. In some embodiments, a prediction ML model may be used to predict the effects of the network modification proposals on the network; said prediction ML model may interact with or comprise the simulated communication network. Where a prediction ML model is used, this prediction ML model may be trained using KPI data from the communications network. The prediction ML model may be any type of ML model, for example: a neural network, a random forest, or support vector machine.

An example training process for a prediction ML model in accordance with some embodiments is as follows. In the example the prediction ML model is a neural network. The neural network is trained to predict the effects of each of the proposals; in this example there are first, second and third network modification proposals, wherein the third network modification proposal has been generated by combining the first and second network modification proposals as discussed above. The prediction ML model (neural network in this example) is trained using KPI data from a communication network. The prediction ML model then predicts the effect of each of the proposals (separately) on the communication network, using the state of the communication network as simulated by the simulated communication network. The output of the predictions can then be used to determine which of the network modification proposals to implement. In the example in accordance with some embodiments the network modification proposal that is predicted to have the most beneficial effect on the communication network (for example, which is predicted to cause the largest positive change in KPI metrics) is selected. In other embodiments the selection of which network modification proposal to implement may be made on a different basis, for example, based on which of the network modification proposals would necessitate the minimum amount of change to the network configuration, or based on another basis. In embodiments wherein the third network modification proposal is generated by combining the second and third network modification proposals (as in the present example) the prediction ML model may be configured to predict whether applying the combined network modification proposal would give a better or worse result than applying only the first or second network modification proposal; this result may be output as a binary value (for example, 1 where the combined proposal is better, 0 where the combined proposal is worse).

When the predictions for the effects of implementing each of the network modification proposals have been predicted, using the simulated communication network that simulates the state of the communication network, the method then continues with the selection of one (or more) of the network modification proposals based on the predicted implementation effects. The selection is shown in step S108 of FIG. 1. Although more than one network modification proposal may be selected and subsequently implemented, typically a single network modification proposal is selected and subsequently implemented. The step of selecting (typically) one of the network modification proposals may be performed in accordance with a computer program stored in a memory 23, executed by a processor 21 in conjunction with one or more interfaces 22 of ML agent 20A, as illustrated by FIG. 2A. Alternatively, the step of selecting one of the network modification proposals may be performed by selector 27 of ML agent 20B, as shown in FIG. 2B. The basis (that is, the criterion or criteria) upon which the selection is made may vary between embodiments, as discussed above. Typically, the selection basis is dictated by the most important factors decided by the operator of the communication network. By way of example, if improving network performance (that is, improving measured KPI values) is of more importance than minimising the energy expended executing network modifications such as adjusting antenna tilt values, then the selection may be made on the basis of which network modification proposal is predicted to provide the best KPI value improvement. Two (or more) network modification proposals may be suitable for combination where the modifications in the proposals complement one another, for example, where one proposal includes activating part or all of a currently deactivated base station to provide additional traffic capacity and another proposal includes redirecting the tilt on one or more existing antennas to improve coverage. By contrast, two (or more) network modification proposals may be unsuitable for combination where the modifications in the proposals contradict one another, for example, where one proposal includes increasing tilt angles of antennas for a given group of base stations and another proposal includes decreasing tilt angles for the same base stations (this may be the case where, for example, the proposals aim to provide improved coverage to different geographical areas).

Where the selected network modification proposal to be implemented is obtained from a single proposal agent (in the example discussed above, from the first proposal agent or second proposal agent), the method may then continue with the step of initiating the modification of the communication network based on the proposal as discussed below (see step S112 of FIG. 1). Alternatively, where the selected network modification proposal to be implemented is not obtained from a single proposal agent (because it is generated using network modification proposals from the proposal agents, such as in the example discussed above wherein the third network modification proposal is generated by combining the first and second network modification proposals), the method may then continue with determining the respective weightings of the first and second network modification proposals in the generated network modification proposal. The step of determining the weightings of the first and second network modification proposals is shown in S110 of FIG. 1.

The step of selecting one of the network modification proposals may be performed in accordance with a computer program stored in a memory 23, executed by a processor 21 in conjunction with one or more interfaces 22 of ML agent 20A, as illustrated by FIG. 2A. Alternatively, the step of selecting one of the network modification proposals may be performed by selector 27 of ML agent 20B, as shown in FIG. 2B. In some embodiments, the determination of the respective weightings of the first and second network modification proposals in the selected network modification proposal may be made by the prediction ML model. Where the weighting determination process is performed by the prediction ML model, this process may be combined with the step of predicting the effect of the implementation of the various network modification proposals. In the combined process, the prediction of the effect of the implementation of the third network modification proposal may include testing various weightings for the first network modification proposal and second network modification proposal in the third network modification proposal and predicting the effect of implementation based on the most advantageous of the tested weightings. Alternatively, in some embodiments, a weighting ML model is used to determine the respective weightings of the first network modification proposal and the second network modification proposal in the third network modification proposal.

The weighting ML model, similar to the prediction ML model, may be any suitable type of ML model. Examples of suitable types include neural networks and random forests. Similarly, the weighting ML model may be trained in any suitable way. An example of a suitable training method is utilising RL, as discussed above. Where the weighting ML model is trained using RL, the environment is a simulation of the communication network; in some embodiments, this may be the same simulation as is used by the prediction ML model where both ML models are present. Where the weighting ML model is trained using RL, the weighting ML model may be referred to as a multi-objective RL model, as it is performing multi-objective optimisation.

The actions proposed by the weighting ML model may be the weights of the respective network modification proposals, with the reward being based on the predicted effect on the communication network (for example, based on predicted KPI improvements). As is the case with the other ML models discussed herein, the ML model may be trained using the simulated communication network before being used to determine respective weightings for a real communication network.

Once the network modification proposal (or proposals where plural proposals are selected) to implement has been selected and, if applicable, the respective weightings determined, the method then continues with the initiation of the modification of the communication network based on the selected network modification proposal(s). The initiation step is shown as S112 in FIG. 1. The step of modifying the communication network may be performed in accordance with a computer program stored in a memory 23, executed by a processor 21 in conjunction with one or more interfaces 22 of ML agent 20A, as illustrated by FIG. 2A. Alternatively, the step of modifying the communication network may be performed by modifier 28 of ML agent 20B, as shown in FIG. 2B. The step of initiating the modification of the communication network may comprise, for example, sending instructions to one or more base stations to activate or deactivate all or part of the base stations, to alter the operational parameters of one or more base stations (for example, adjusting antenna tilt values thereby altering the coverage provided by the base stations), and so on. Where the method is executed by a ML agent that is or forms part of a base station, the ML agent may directly modify the configuration of at least that base station. Where the ML agent wishes to modify the configuration of other base stations (either because the ML agent is not or does not form part of a base station, or because the ML agent wishes to modify the configuration of a base station other than that which it is/is part of), the step of initiating the modification of the communication network may comprise transmitting instructions to other base stations. In some embodiments, the instructions from the ML agent may be distributed to one or more base stations via a further component, for example, may be sent via a core network node (in these embodiments, the ML agent may be or may form part of the core network node).

In some embodiments, following the initiation of the modification of the communication network based on the selected modification proposal, the method may further comprise waiting a determined time interval before considering further network modification proposals. Where the proposal agents form part of a system including the ML agent, the proposal agents may be configured to not generate network modification proposals until the determined time interval has elapsed. Alternatively, where the proposal agents are separate from, and not under the control of, the ML agent, the ML agent may be configured to store or to ignore network modification proposals from the proposal agents and to not evaluate network modification proposals until after the determined time interval has elapsed. In some embodiments, the ML agent may trigger the proposal agents to begin generating new network modification proposals following the elapse of the determined time interval.

In some embodiments, the determined time interval may be a set value that is determined, for example, by a network operator. In other embodiments, the determined time interval may be determined using an implementation ML model. The determined time interval may be determined prior to initiating the network modification. The implementation ML model, like the other ML models discussed above, may be any suitable type of ML model and may be trained in any suitable way. In some embodiments, the implementation ML model may be trained using RL and using input KPI data from the communications network. The determined time interval may be provided in the form of a number of evaluation steps, that is, where the proposal agents are configured to evaluate the network at a predetermined frequency (with the aim of generating network modification proposals), the determined time interval may indicate that a given number of evaluation steps may be omitted.

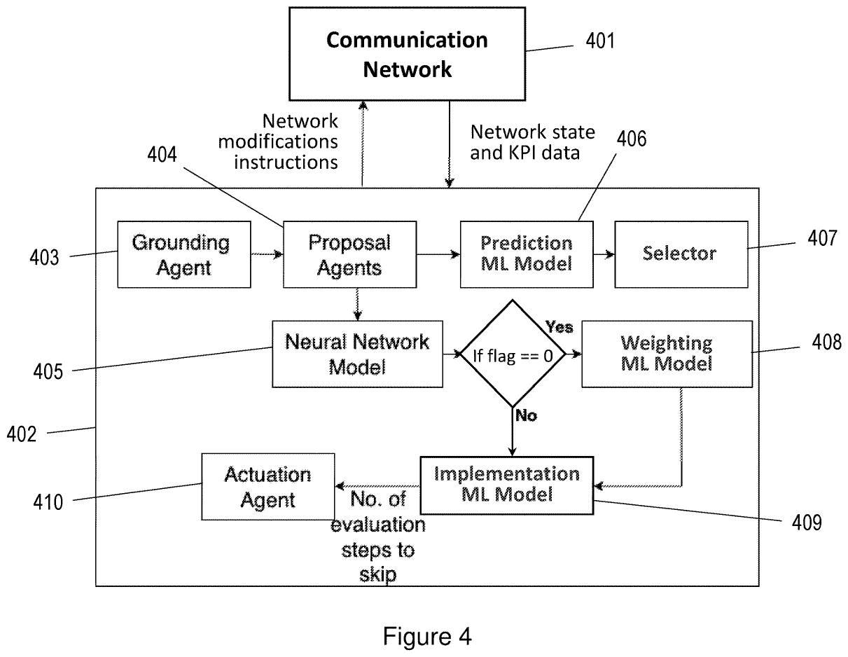

FIG. 4 is a schematic diagram showing an example of a system in accordance with some embodiments. In the system shown in FIG. 4, communication network 401 transmits network state data (including KPI data) to a system 402 comprising the ML agents and receives network modification instructions. In the example shown in FIG. 4, a grounding agent 403 is used to receive the network state data and supply this to other parts of the system, such as the proposal agents 404. In this example, the system comprises the proposal agents, of which there are two. The proposal agents receive intents from network users/customers, and generate the first and second network modification proposals based on the received intents. In the present example, the neural network model 405 generates the third network modification proposal by combining the first and second network modification proposals. The generated proposals pass to the prediction ML model 406, which then predicts the effects of the implementation of each network modification proposal on the state of the communication network using a simulated communication network (virtual twin). In some embodiments, a separate prediction agent may be used to evaluate each network modification proposal (wherein the prediction agents collectively are referred to as the prediction ML model). Based on the results of this prediction, the selector 407 selects a network modification proposal to be implemented.

In the example shown in FIG. 4, where it is determined that the proposal to be implemented is the third (combined) network modification proposal, the weighting ML model 408 is used to calculate the respective weightings of the first and second network modification proposals in the combined network modification proposal, then the implementation ML model 409 is used to calculate a determined time interval that should be applied prior generating further network modification proposals. Alternatively, where it is determined that the proposal to be implemented is the first or second network modification proposal, the weighting ML model is not required. When the determined time interval has been determined by the implementation ML model, the actuation agent 410 then initiates the modification of the communication 401 network by sending network modification instructions.

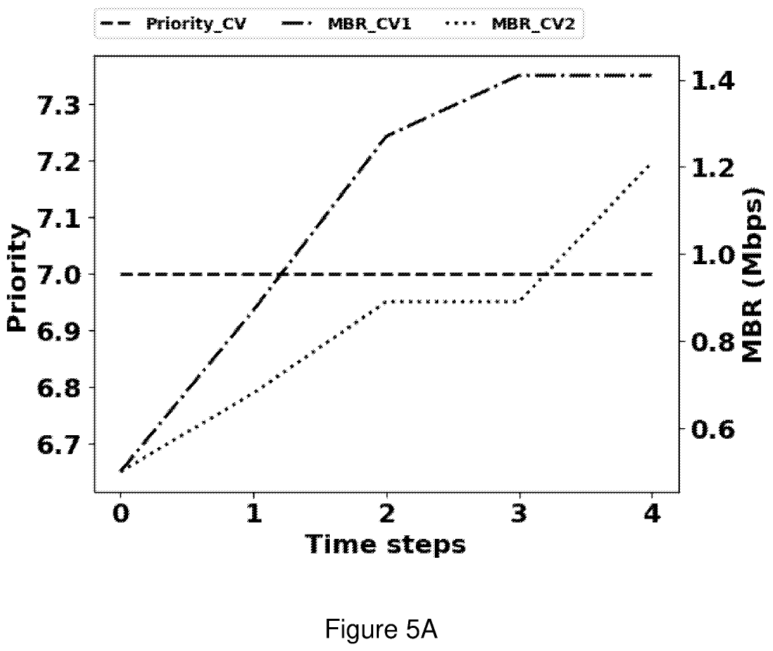

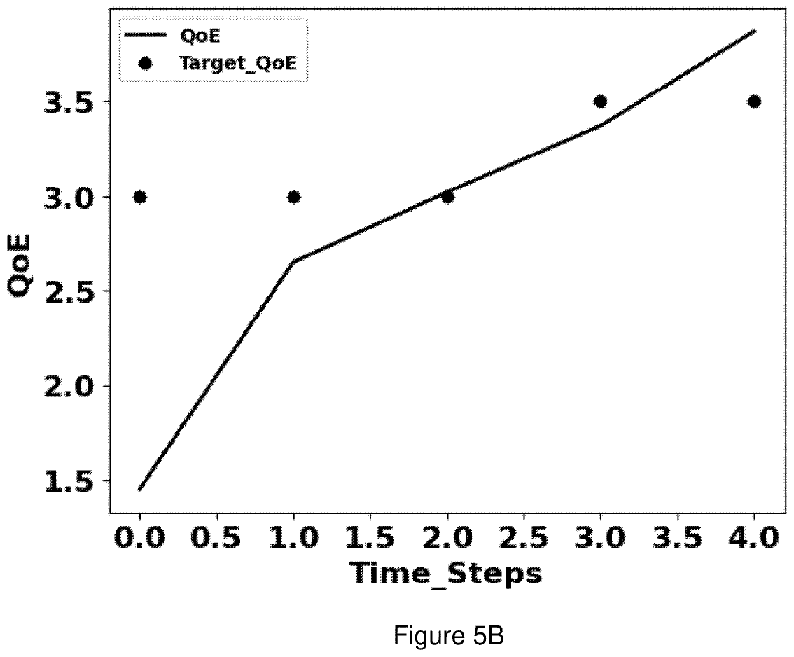

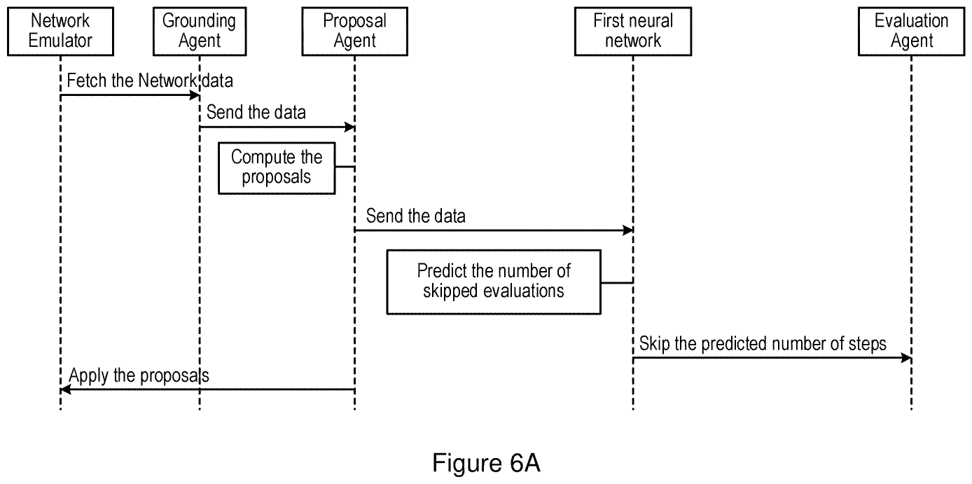

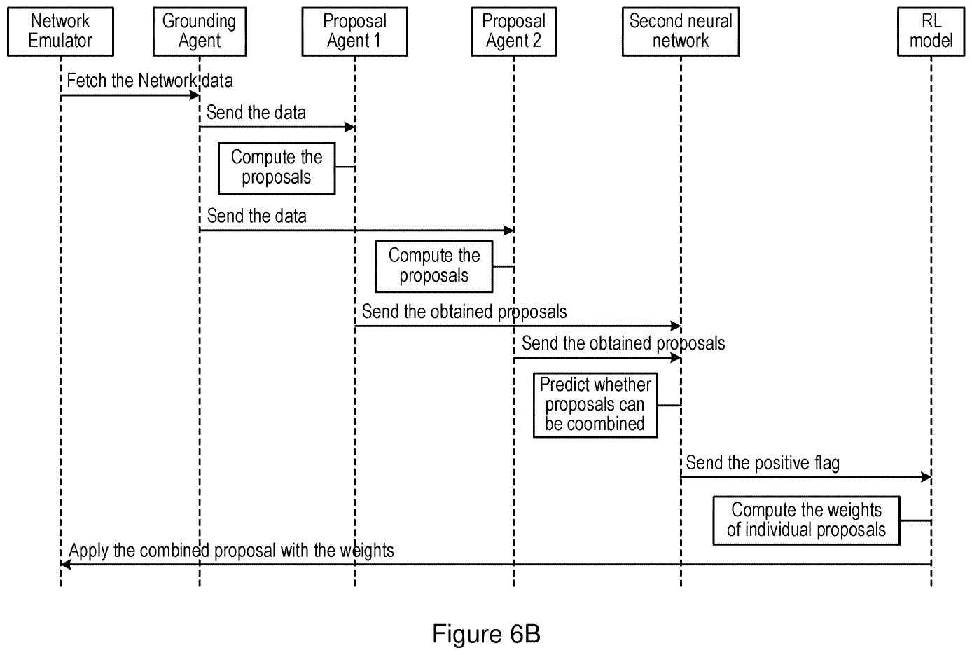

FIG. 5A and FIG. 5B (collectively FIG. 5) are results plots showing an example of the effect of an embodiment on the time taken to reach KPI targets. In the example shown in FIG. 5, two network modification proposals are generated by proposal agents; the first is intended to alter the priority of services within the network and the second is intended to increase the maximum bit rate (MBR) of the network. A third network modification proposal is generated by combining the first and second network modification proposals; in this example the proposals are weighted equally. In this example, it is determined to apply the combined proposal. FIG. 5A shows the effects of modifying the network based on: the first network modification proposal (priority proposal referred to in FIG. 5A as “Priority_CV”); the second network modification proposal (MBR proposal referred to in FIG. 5A as “MBR_CV2”); and the combined (third) network modification proposal (referred to in FIG. 5A as “MBR_CV1”). The x axis in FIG. 5A shows the number of time steps over which the network has been modified based on the various network modification proposals, while the two y axes show priority and MBR respectively. As shown in FIG. 5A, the combined proposal results in a faster improvement in the priority and MBR than either of the first and second network modification proposals. This rapid improvement is illustrated by FIG. 5B, in which the x axis shows the number of time steps over which the network has been modified based on the third network modification proposal and the y axis shows the QoE value. FIG. 5B illustrates how a target Quality of Experience (QoE) based on the priority and MBR may be achieved in a small number of time steps, specifically 4 time steps, using the combined model, and with a rapid rate of improvement. For comparison, applying the first network modification proposal (priority proposal) resulted in the target QoE being achieved in 9 time steps, while applying the second network modification proposal (MBR proposal) resulted in the target QoE being achieved in 7 time steps.

Embodiments may allow network performance targets (such as target KPI values) to be achieved faster than may be achieved using existing systems, specifically by supporting the use of network modifications that simultaneously address plural proposals where appropriate. Embodiments may also allow network performance evaluations to be reduced where not required, thereby saving network resources (such as processing resources). Embodiments may also be implemented without requiring substantial modification to existing network architecture.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

In general, the various exemplary embodiments may be implemented in hardware or special purpose circuits, software, logic or any combination thereof. For example, some embodiments may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like. References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms. The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1. A computer-implemented method for modifying the configuration of a communication network using a machine learning (ML) agent, the method comprising:
receiving a first network modification proposal from a first proposal agent and a second network modification proposal from a second proposal agent;
generating a third network modification proposal using the first network modification proposal and the second network modification proposal;
predicting the effect of the implementation of the first network modification proposal, the second network modification proposal and the third network modification proposal on a state of the communication network using a simulated communication network, wherein the simulated communication network simulates the state of the communication network;
selecting one of the network modification proposals based on the predicted implementation effects and, where the third network modification proposal is selected, determining respective weightings of the first network modification proposal and second network modification proposal in the third network modification proposal; and
initiating the modification of the communication network based on the selected network modification proposal.

2. The method of claim 1, wherein the method further comprises receiving a network status information from the communication network, and updating the simulated communication network using the network status information.

3. The method of claim 1, further comprising generating the first network modification proposal using the first proposal agent and generating the second network modification proposal using the second proposal agent.

4. The method of claim 3, wherein the first proposal agent and the second proposal agent utilise ML models trained using Reinforcement Learning (RL) to generate the network modification proposals.

5. The method of claim 3, wherein the first proposal agent and the second proposal agent generate the network modification proposals based on Key Performance Indicators (KPIs) for the communications network.

6. The method of claim 5, wherein the KPIs comprise one or more of: Quality of Experience (QoE); packet loss; and latency.

7. The method of claim 1, wherein the third network modification proposal is generated by combining the first network modification proposal and the second network modification proposal.

8. The method of claim 1, wherein a prediction ML model is used to predict the effects of the network modification proposals.

9. The method of claim 8, wherein the prediction ML model is trained using Key Performance Indicator (KPI) data from the communications network.

10. The method of claim 9, wherein the network modification proposal predicted to provide the largest increase in KPI values is selected.

11. The method of claim 8, wherein, when the third network modification proposal is selected, the prediction ML model is used to determine the respective weightings of the first network modification proposal and the second network modification proposal in the third network modification proposal.

12. The method of claim 8, wherein, when the third network modification proposal is selected, a weighting ML model is used to determine the respective weightings of the first network modification proposal and the second network modification proposal in the third network modification proposal.

13. (canceled)

14. The method of claim 1, further comprising, when the modification of the communication network based on the selected network modification proposal has been initiated, waiting a determined time interval before considering further network modification proposals.

15. The method of claim 14, wherein the time interval is determined using an implementation ML model.

16. The method of claim 15, wherein the implementation ML model is trained using RL and using input KPI data from the communications network.

17. The method of claim 14, further comprising, when the determined time interval elapses, triggering the generation of further network modification proposals.

18. The method of claim 1, wherein the initiation of modification of the communication network comprises instructing the activation and/or deactivation of all and/or part of one or more base stations in the communication network.

19. The method of claim 1, wherein the initiation of modification of the communication network comprises altering the operational parameters of one or more base stations in the communication network.

20. The method of claim 1, wherein the state of the communication network comprises the configuration of one or more base stations in the communication network, the distribution of network traffic in the communication network and/or the performance of the communication network relative to KPIs.

21. A machine learning (ML) agent configured to modify the configuration of a communication network using a ML model, the ML agent comprising processing circuitry and a memory containing instructions executable by the processing circuitry, whereby the ML agent is operable to:
receive a first network modification proposal from a first proposal agent and a second network modification proposal from a second proposal agent;
generate a third network modification proposal using the first network modification proposal and the second network modification proposal;
predict the effect of the implementation of the first network modification proposal, the second network modification proposal and the third network modification proposal on a state of the communication network using a simulated communication network, wherein the simulated communication network simulates the state of the communication network;
select one of the network modification proposals based on the predicted implementation effects and, where the third network modification proposal is selected, determine respective weightings of the first network modification proposal and second network modification proposal in the third network modification proposal; and
initiate the modification of the communication network based on the selected network modification proposal.

22.-40. (canceled)
